(19) United States
(12) Patent Application Publication
(10) Pub. No.: US 2007/0129839 A1
(43) Pub. Date: Jun. 7, 2007

(54) System for controlling semiconductor device manufacturing process and method of controlling semiconductor device manufacturing process

(75) Inventors: Osamu Tsubakida, Kawasaki (JP); Tatsuya Hayashi, Kawasaki (JP); Yuki Nishimura, Kawasaki (JP); Satoshi Ishimoto, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/393,653

(22) Filed: Mar. 31, 2006

(30) Foreign Application Priority Data
Dec. 5, 2005 (JP) 2005-350382

(51) Int. Cl. G06F 19/00

(52) U.S. Cl. 700/121

(57) ABSTRACT

In a system for controlling a semiconductor device manufacturing process, a recipe indicating a control condition for controlling processing in a semiconductor manufacturing apparatus is calculated by a computation performed using manufacturing data obtained in the semiconductor device manufacturing process and a predetermined algorithm, and when the recipe cannot be derived, an alternative recipe prepared beforehand is transmitted to a manufacturing management system for managing the semiconductor manufacturing apparatus. The alternative recipe may be derived using the predetermined algorithm by a recomputation in which input conditions are changed. When a recipe cannot be derived by the recomputation, a planned recipe with which semiconductor devices processed by the manufacturing process fall within specification values may be used as the alternative recipe.

### CROSS-REFERENCE TO RELATED APPLICATIONS

This application is based on and claims priority of Japanese Patent Application No. 2005-350382 filed on Dec. 5, 2005, the entire contents of which are being incorporated herein by reference.

### BACKGROUND OF THE INVENTION

1. Field of the Invention

The present invention relates to a system for controlling a semiconductor device manufacturing process and a method of controlling a semiconductor device manufacturing process.

2. Description of the Prior Art

In recent years, smaller-size, higher-density semiconductor devices are being demanded, and it is becoming difficult to maintain wafer quality constant and manage the maintaining of the state of a semiconductor manufacturing apparatus in a semiconductor device manufacturing process.

On the other hand, computer-integrated manufacturing (CIM) systems, in which all of a semiconductor manufacturing apparatus used in a manufacturing process, processing conditions and working data in the semiconductor manufacturing apparatus, and the like are managed by a computer, have spread widely. Thus, effective production support for an improvement in quality, an improvement in yield, a reduction of working mistakes, and the like has come to be performed.

However, in an actual manufacturing step, if the sizes of semiconductor devices are reduced and the densities thereof are increased, the semiconductor devices are not necessarily processed under a condition in which a semiconductor manufacturing apparatus is stable. Thus, there may be cases where the finished precision of the semiconductor devices is lowered.

Generally, when a semiconductor manufacturing apparatus is operated for a long time, adjusted values thereof are changed, and consumable components are deteriorated. Thus, a processing state tends to change gradually. Accordingly, control systems have come to be used which monitor the state of a semiconductor manufacturing apparatus and at the same time perform appropriate control according thereto so that the finished precision of semiconductor devices can be stably maintained highly constant even if the state of the semiconductor manufacturing apparatus changes. Typical examples of such a system include an advanced process control (APC) system suggested in a SEMATECH guideline.

A semiconductor device manufacturing system is constructed by combining a manufacturing process control system such as the above-described APC system and manufacturing management systems such as manufacturing execution system (MES) and a cell controller (CC). The APC system which performs a computation necessary for controlling a manufacturing process obtains necessary data from the MES. Upon receiving data, the APC system finds an optimum control condition (hereinafter referred to as a “recipe”) for a semiconductor manufacturing apparatus based on the contents of the received data using an algorithm according to a mathematical process model set beforehand.

As described above, in a system which manages manufacture using a computer, it is desired that a semiconductor manufacturing apparatus be prevented from mass-producing defective products and that the entire system be prevented from stopping due to a failure in the computer.

As a technology relating to this, for example, Japanese Unexamined Patent Publication No. Hei 9-129529 discloses a system in which recipe managing means connected to an apparatus control unit for controlling a semiconductor manufacturing apparatus and a central control unit is provided and in which in the case of a system down of the central control unit, the recipe managing means controls processing instead to prevent a down of the entire system.

Further, Japanese Unexamined Patent Publication No. Hei 11-312196 discloses a computer production-management system in which a dedicated computer for transmitting necessary information is provided between a cell computer for managing work for each manufacturing step and a manufacturing apparatus, and in which the manufacturing apparatus is caused to continuously operate even in the case where a failure occurs in the cell computer to result in a down.

Moreover, Japanese Unexamined Patent Publication No. 2000-343386 discloses a system in which a data relay unit is provided between an apparatus control unit and a central control unit to check apparatus control information and in which defective products can be prevented from occurring in the case where a mistake has been made in the setting of processing conditions for operating a manufacturing apparatus.

Furthermore, Japanese Unexamined Patent Publication No. 2005-39096 discloses means for changing a product type parameter of a product to be manufactured and thus preventing the operation of a manufacturing apparatus from stopping in the case where an error has occurred in the manufacturing apparatus.

It should be noted that Japanese Unexamined Patent Publication No. 2004-349644 discloses a semiconductor device manufacturing system obtained by combining a manufacturing management system and a manufacturing process control system.

As described above, a semiconductor device manufacturing system has been developed which manufactures semiconductor devices with high precision by causing an APC system and a CIM system to cooperate with each other.

However, even in the case where such a system is used, it has revealed that the following inconveniences occur.

In the manufacture of semiconductor devices using an APC system, an optimum recipe for controlling a manufacturing apparatus is dynamically derived using a mathematical process model utilizing data from an inspection result before processing of an object manufacturing process and data from an inspection result after the processing. Since the APC system dynamically performs a computation in this way, the computation may fail for a reason such as lack of data.

When a computation of an APC recipe has failed, an APC recipe cannot be transmitted to a CIM system, and therefore the manufacture of semiconductor devices by the CIM system is stopped. In particular, in a fully automated line as in a factory in which wafers having diameters of 300 mm are dealt with, there is a risk that the entire line of a manufacturing process may be stopped due to a stop of a step, e.g., an etching step, in which a problem has occurred.

On the other hand, in the case where a computation of an APC recipe has failed, it is also possible to derive a recipe through the involvement of a human. However, parameters of external factors such as fluctuating atmospheric pressure cannot be reflected on an APC recipe. Accordingly, there is the problem that the finished precision of semiconductor devices significantly deteriorates.

It should be noted that Japanese Unexamined Patent Publication Nos. Hei 9-129529, Hei 11-312196, 2000-343386, and 2005-39096 are intended to eliminate inconveniences for the case where a failure has occurred in a manufacturing management system for controlling a manufacturing apparatus or on a manufacturing apparatus side, and are not targeted at a manufacturing process control system which generates a recipe.

### SUMMARY OF THE INVENTION

According to one aspect of the present invention, there is provided a system for controlling a semiconductor device manufacturing process, in which a recipe indicating a control condition for controlling processing in a semiconductor manufacturing apparatus is calculated by a computation performed using manufacturing data obtained in the semiconductor device manufacturing process and a predetermined algorithm, and when the recipe cannot be derived, an alternative recipe prepared beforehand is transmitted to a manufacturing management system.

Further, in the system for controlling a semiconductor device manufacturing process according to the above-described aspect, the alternative recipe may be derived using the predetermined algorithm by a recomputation in which input conditions are changed. When a recipe cannot be derived by the recomputation, a planned recipe with which semiconductor devices processed by the manufacturing process fall within specification values may be used as the alternative recipe.

In the system for controlling a semiconductor device manufacturing process according to this aspect, the alternative recipe to be returned to the manufacturing management system is prepared beforehand inside the manufacturing process control system. Thus, even in the case where an optimum recipe cannot be derived, it does not happen that a recipe cannot be returned to the manufacturing management system, and the semiconductor manufacturing apparatus is not stopped. Accordingly, device manufacture and device quality are not adversely affected.

According to another aspect of the present invention, there is provided a method of controlling a semiconductor device manufacturing process, comprising the steps of: calculating a recipe indicating a control condition for controlling processing in a semiconductor manufacturing apparatus by a computation performed using manufacturing data obtained in the semiconductor device manufacturing process and a predetermined algorithm; and when the recipe cannot be derived, transmitting an alternative recipe prepared beforehand to a manufacturing management system for managing the semiconductor manufacturing apparatus.

### BRIEF DESCRIPTION OF THE DRAWINGS

FIG. 1 is a configuration diagram showing one example of a semiconductor device manufacturing system to which an APC system is applied.

FIG. 2 is a diagram for explaining processing in the semiconductor device manufacturing system.

FIG. 3 is an explanatory diagram showing the relationship between the APC system and a manufacturing apparatus.

FIGS. 4A to 4C are views (part 1) for explaining an application example of the APC system in an etching step.

FIG. 5 is a view (part 2) for explaining the application example of the APC system in the etching step.

FIG. 6 is a view showing the change of the flow rate of etching gas with respect to processing time in an etching apparatus.

FIG. 7 is a diagram for explaining processing according to a first embodiment.

FIG. 8 is a diagram showing one example of event data.

FIG. 9 is one example (in normal situation) of a response recipe management table for managing APC recipes.

FIG. 10 is a flowchart showing one example of processing according to the first embodiment.

FIG. 11 is one example (in abnormal situation) of a response recipe management table for managing APC recipes.

FIG. 12 is a flowchart showing one example of processing according to a second embodiment.

FIG. 13 is one example of an inquiry screen for an operator.

FIG. 14 is a diagram for explaining message communication between an APC system and a CC system.

FIG. 15 is one example of specifications of a packet used for message communication.

### DESCRIPTION OF THE PREFERRED EMBODIMENT

Hereinafter, embodiments of the present invention will be described with reference to the accompanying drawings.

### (1) First Embodiment

In a first embodiment, first, an overview of a semiconductor device manufacturing system will be described. Next, a description will be given of the derivation of an APC recipe for preventing a CIM system from stopping. Then, a description will be given of a method of controlling a semiconductor device manufacturing process for preventing the CIM system from stopping.

(Overview of Semiconductor Device Manufacturing System)

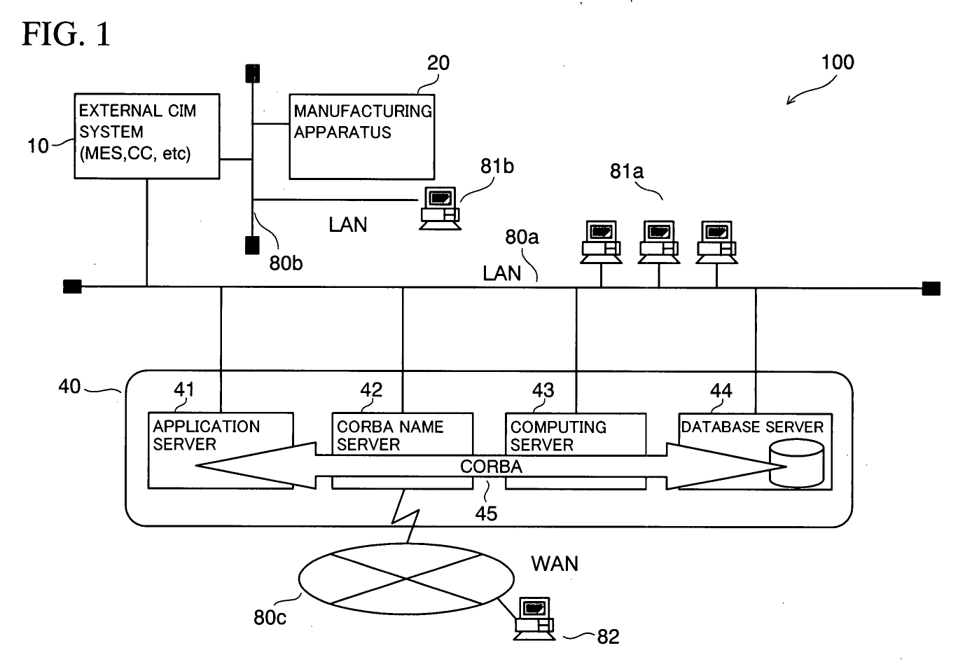

FIG. 1 is a schematic configuration diagram showing one example of a semiconductor device manufacturing system 100. The semiconductor device manufacturing system 100 includes an APC system 40, an external CIM system 10, and a manufacturing apparatus 20 as basic components.

The APC system 40 includes an application server 41, a Common Object Request Broker Architecture (CORBA) name server 42, a computing server 43, and a database server 44.

The application server 41 stores application programs for realizing processing functions of the APC system 40, and executes and manages the processing by the application programs. The application programs include, for example, a program for storing manufacturing data collected from an MES or a CC system with predetermined timing in the database server 44 systematically by a predetermined classification scheme, a program for setting a filter condition for selecting only a predetermined entry in data when the data is classified, a program for setting which manufacturing apparatus 20's data is used to perform a recipe computation, and a program for specifying an algorithm used for a recipe computation and setting conditions for simulating an algorithm under development or an existing algorithm.

The CORBA name server 42 executes and manages processing through CORBA. CORBA is middleware which has been developed by the Object Management Group (OMG) and in which infrastructures of distributed system environments are standardized. In CORBA, the interfaces of all objects are defined in a language called an interface definition language (IDL), and interoperation between different platforms and between different languages is realized through this IDL. Communication between servers in the APC system 40 is performed using this CORBA 45.

The computing server 43 is configured to be capable of performing a computation of an APC recipe using an algorithm stored in the database server 44. The algorithm used for the computation is specified according to a filter condition and started on the computing server 43. Further, this computing server 43 is also configured to be capable of simulating a computation using an algorithm under development or an existing algorithm.

The database server 44 includes a computation result database in which an APC recipe generated as a result of a computation in the computing server 43 is stored, a simulation result database in which a simulation result of an algorithm is stored, and a log management database in which data used to execute a computation and computation execution information indicating an intermediate result of the computation are stored and managed as a log. Further, the database server 44 includes a manufacturing history database in which manufacturing data collected by the APC system 40 from a CC system 50 is stored, an algorithm database in which an algorithm used for a computation is stored, and an APC filter database in which a filter condition is stored as APC filter data.

As described above, in the APC system 40, servers suited for purposes of processing are provided so as to be physically dispersed, and the APC system 40 is configured so that the servers can perform processing independently or concurrently.

The APC system 40 is connected to APC operation terminals 81a through a LAN 80a. Using the APC operation terminals 81a, operations such as various settings, data inputs, and processing execution instructions, can be performed on each server of the APC system 40.

To the LAN 80a, external CIM systems 10 such as an MES and a CC system are connected. Thus, data communication can be performed between the APC system 40 and the external CIM systems 10. The external CIM systems 10 are connected to the manufacturing apparatus 20 on a manufacturing line through a LAN 80b, and manage processing conditions, measurement conditions, and the like in the manufacturing apparatus 20 using computers. Manufacturing data obtained after the completion of processing in the manufacturing apparatus 20 is transmitted to the external CIM systems 10 and then to the APC system 40 to be processed. To the LAN 80b, a terminal 81b for collecting external factors is also connected.

Moreover, the CORBA name server 42 of the APC system 40 is connected to an external terminal 82 through a wide area network (WAN) 80c. This makes it possible to perform data communication with a different manufacturing location.

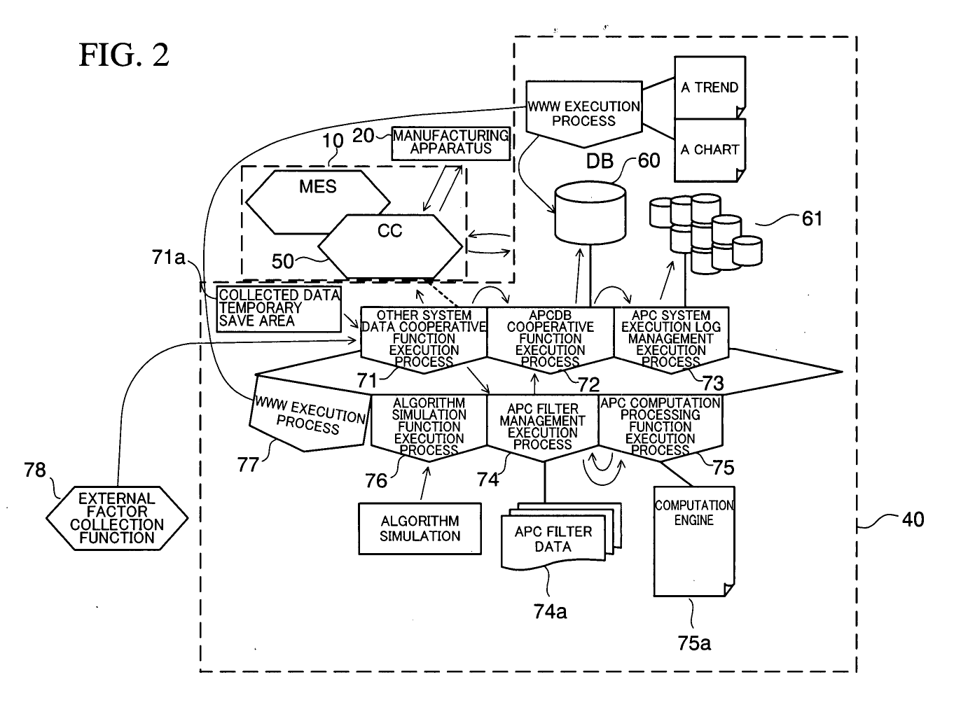

FIG. 2 is a diagram for explaining processing by the APC system 40. Here, the CC system 50 is used as an external CIM system, and a description will be given by taking processing performed between the CC system 50 and the APC system 40 as an example.

In the semiconductor device manufacturing system 100, the APC system 40 executes processing using an other system data cooperative function execution process 71, an APCDB cooperative function execution process 72, an APC system execution log management execution process 73, an APC filter management execution process 74, an APC computation processing function execution process 75, an algorithm simulation function execution process 76, and a WWW (World Wide Web) execution process 77. Data communication between execution processes is mainly performed using CORBA 45.

The operation of the APC system 40 thus configured will be described below.

First, upon the completion of processing, the manufacturing apparatus 20 provides the CC system 50 with notification of various kinds of summary information obtained by the processing. This summary information includes processing conditions, measurement conditions, and measurement data; and also includes entries such as a management number such as a system ID, a product name indicating which product the data relates to, an apparatus name indicating which semiconductor manufacturing apparatus the manufacturing data relates to, a major step name and a minor step name indicating which stage of the manufacturing process the manufacturing data has been obtained in, and an event date and time indicating the date and time at which the processing has been performed.

The various kinds of summary information provided from the manufacturing apparatus 20 to the CC system 50 is stored in a database (not shown) provided in the CC system 50.

The APC system 40 inquires of the CC system 50 as to various kinds of summary information. This inquiry is performed by the other system data cooperative function execution process 71 of the APC system 40, and the synchronizing of the system on the other side is unnecessary. The timing of this inquiry from the APC system 40 to the CC system 50 is set before the APC system 40 is started. For example, an interval between when processing by the manufacturing apparatus 20 is completed and notification of various kinds of summary information thereon is provided to the CC system 50 and when next processing by the manufacturing apparatus 20 is completed and notification of various kinds of summary information thereon is provided to the CC system 50, i.e., the timing of the completion of processing in the manufacturing apparatus 20, is set as the timing of an inquiry. In the case where there are a plurality of manufacturing apparatuses 20, the timing of an inquiry is set according to the processing time of each manufacturing apparatus 20.

Further, in the APC system 40, apparatus information, various kinds of summary entries, and data (hereinafter referred to as event entries and data) to be registered in a database 60 are registered beforehand.

The other system data cooperative function execution process 71 obtains information which is possessed by the CC system 50 and which concerns event entries and data on a product processed by the manufacturing apparatus 20.

Moreover, the other system data cooperative function execution process 71 also takes in real-time sensor information of the manufacturing apparatus 20 and information such as atmospheric pressure through an external factor collection function 78. The external factor collection function 78 is realized by, for example, a Fault Detection and Classification (FDC) system and connected to the APC system 40 through a LAN or the like.

In the other system data cooperative function execution process 71, a predefined event entry of each manufacturing apparatus 20 is extracted by filtering, and a pair of the entry and data matching the entry is formed. Further, other appendant information used as key entries are added thereto, and data is passed to the APCDB cooperative function execution process 72.

The APCDB cooperative function execution process 72 registers data formed by the other system data cooperative function execution process 71 in the database 60.

In the APC filter management execution process 74, filtering is performed using an APC filter data 74a in which a filter condition is set beforehand, and entries necessary for an APC recipe computation are selected. Further, an algorithm used for the APC recipe computation is specified based on identification information such as an ID number given to the algorithm according to the filter condition. The algorithm used here is created beforehand and stored in the database 60. The APC filter management execution process 74 gives the APC computation processing function execution process 75 an instruction to start APC computation processing.

In the APC computation processing function execution process 75, the algorithm specified in the APC filter management execution process 74 is started, and an APC recipe computation is performed using data on the entries selected in the APC filter management execution process 74. The APC recipe computation is performed by a computation engine 75a.

After the completion of the APC recipe computation, a calculated optimum recipe is returned to the APC filter management execution process 74, and the APC filter management execution process 74 passes the optimum recipe to the APCDB cooperative function execution process 72, thus registering the optimum recipe in the database 60. At this time, computation execution information on the APC recipe computation is stored as a log in a various execution log management database 61 from the APC system execution log management execution process 73.

When lot processing is performed, the CC system 50 inquires of the APC system 40 as to an optimum recipe for the processing. The APC system 40 searches the database 60 whether or not an appropriate optimum recipe exists in response to the inquiry from the CC system 50. In the case where there is an optimum recipe, the optimum recipe is extracted from the database 60 to be transmitted to the CC system 50. The CC system 50 transmits the received optimum recipe to the appropriate manufacturing apparatus 20, whereby processing in the manufacturing apparatus 20 is controlled according to the optimum recipe.

The above-described processing is repeatedly executed to manufacture semiconductor devices.

Moreover, the APC system 40 also has the function of performing an algorithm simulation. In the algorithm simulation, data on specific entries are extracted from collected manufacturing data to perform data analysis. By utilizing the result of the data analysis as needed, an algorithm under development or a registered algorithm is started to perform a computation. Thus, the operation of the algorithm can be checked, and the result of the computation can be verified.

The algorithm simulation is executed by the algorithm simulation function execution process 76. The algorithm simulation function execution process 76 specifies an algorithm under development or a registered algorithm, and issues an instruction to start a computation to the APC filter management execution process 74. Then, the APC filter management execution process 74 issues an instruction to start a computation to the APC computation processing function execution process 75. After the completion of the computation, the APC computation processing function execution process 75 returns a calculated optimum recipe to the APC filter management execution process 74. The APC filter management execution process 74 passes the optimum recipe to the APCDB cooperative function execution process 72, and the APCDB cooperative function execution process 72 registers the optimum recipe in the database 60.

Further, the APC system execution log management execution process 73 registers, in addition to the optimum recipe, detailed computation execution information as a log in an execution log management database 61. In the database 60 for storing computation results and databases 61 for registering log information, an area dedicated to algorithm simulation is provided, and the result of executing an algorithm simulation is stored in this dedicated area. The purpose is to prevent the result of the simulation from affecting the history of the finished quality of products.

Moreover, the WWW execution process 77 makes it possible to refer to the computation results stored in the database 60 and the trend of past manufacturing data using a browser. Furthermore, the simulation results stored in the database 60 can also be referred to.

It should be noted that, in the APC system 40, since manufacturing data to be collected is stored in a collected data temporary save area 71a managed by the other system data cooperative function execution process 71, a manufacturing history can be restored without missing manufacturing data even if a trouble occurs in the database server 44.

Hereinafter, processing by the APC system 40 will be described by taking an etching step as an example.

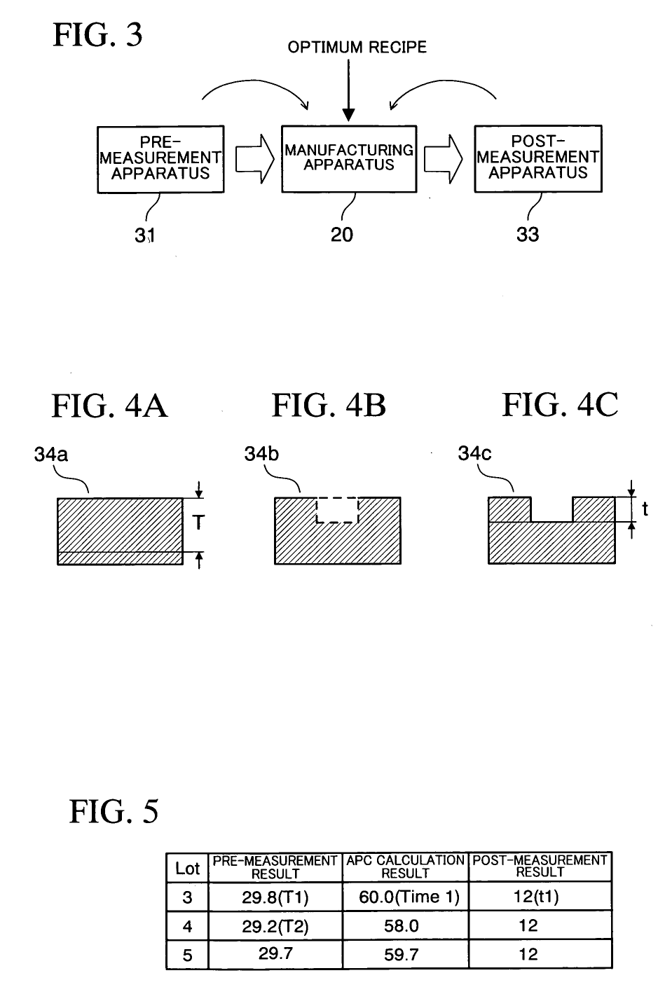

FIG. 3 is a schematic explanatory diagram showing the relationship between the APC system 40 and the manufacturing apparatus 20. Here, an etching apparatus will be described as the manufacturing apparatus 20. A pre-measurement apparatus 31 and a post-measurement apparatus 33 are apparatuses for measuring a film thickness on a wafer. The pre-measurement apparatus 31 measures a film thickness before etching, and the post-measurement measurement apparatus 33 measures a film thickness after etching.

In this example, a condition for performing optimum etching is found using the measurement result of a film thickness before etching and the measurement result of a film thickness after etching in order to stabilize a manufacturing process.

Referring to FIGS. 4A to 5, a method of finding a condition for performing optimum etching will be described. In the etching apparatus, the etching time for which an optimum etching amount (depth) can be obtained is set as a control condition (recipe).

FIG. 4A shows a film 34a on a wafer before etching, and the thickness T thereof is measured by the pre-measurement apparatus 31. FIG. 4B shows a film 34b on the wafer for the case where optimum etching has been performed. FIG. 4C shows a film 34c on the wafer after etching, and the thickness t thereof is measured by the post-measurement apparatus 33.

The film thickness measured by the pre-measurement apparatus 31 before etching and the film thickness measured by the post-measurement apparatus 33 after etching are used in order to perform etching of an optimum depth as shown in FIG. 4B.

As an algorithm for finding an optimum recipe (optimum etching time Time) in the APC system 40, for example, the following calculation formula is used:
Time=(T2−t2)/((T1−t1)/Time1)

Here, (T1−t1) is the difference in film thickness before and after etching for the case of etching performed on a lot previous to an object lot, and Time1 is optimum etching time. Further, (T2−t2) is a target difference in film thickness before and after etching for the case of etching performed on the object lot, T2 is a value obtained as a result of performing pre-measurement, and t2 is a target value of the film thickness.

In FIG. 5, a view summarizing lot-by-lot APC calculation results is shown. In order to find an optimum value (APC calculation result) of etching time for lot 4 using the above-described algorithm, used are the pre-measurement result of lot 3, T1=29.8; the post-measurement result, t1=12; an optimum value of etching time for lot 3, Time1=60; the pre-measurement result of lot 4, T2=29.2; and a target value, t2. Using these values, an optimum value of etching time for lot 4 can be found.

As described above, optimum etching time for a lot which is an object of processing is derived using the measurement results of the film thicknesses before and after etching and the optimum etching time in a previous lot, and the measurement result of the film thickness of the processing object lot and a target value of the film thickness thereof after etching.

Thus, finished precision can be maintained constant, and the manufacturing process can be stabilized.

(Derivation of APC Recipe for Preventing CIM System from Stopping)

As shown in FIG. 2, in the semiconductor device manufacturing system 100, a recipe derived in the APC system 40 is transmitted to the CC system 50 which manages the manufacture of semiconductor devices.

In the case where an optimum APC recipe is not derived in the APC system 40, an APC recipe is not transmitted to the CC system 50, and the semiconductor device manufacturing system 100 stops. As cases in which an APC computation results in an error, there are the following cases.

For example, there are cases where the line widths should normally be measured at five points in a wafer but have been measured at only four points because of a malfunction in an apparatus when line widths of a resist pattern after exposure and development are measured. Since an algorithm for deriving an optimum recipe is premised on data on five points, an optimum recipe cannot be derived in the case of data on four points, and a computation fails.

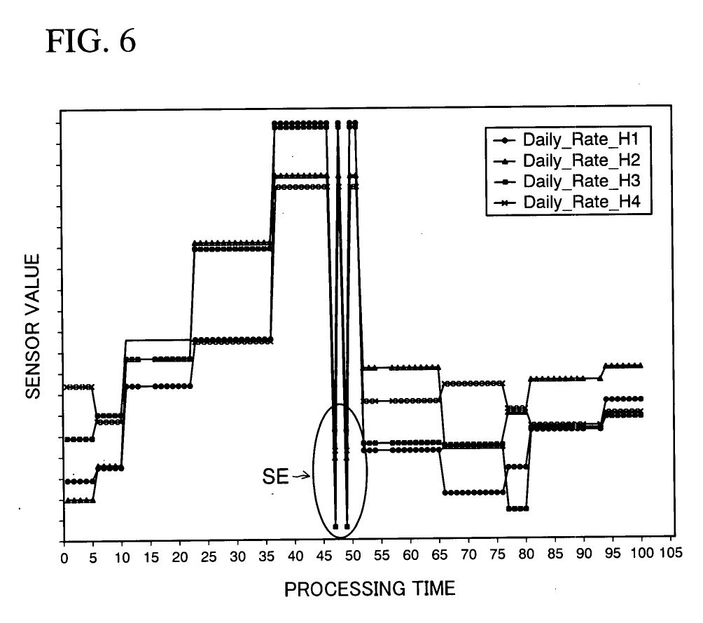

Further, in the case where the trend of the manufacturing apparatus 20 shows an abnormal state, an APC computation also results in an error. FIG. 6 shows the change of the flow rate of etching gas with respect to processing time in an etching step. The horizontal axis of FIG. 6 shows the processing time, and the vertical axis thereof shows a sensor value for the gas, i.e., the flow rate of the gas. In this etching apparatus, the sensor value is determined to be normal in the case where points at which the sensor value does not change are consecutive for three points. In part SE of FIG. 6, the sensor value consecutively changes and is therefore determined to be abnormal. Moreover, in the case where the sensor value does not fall in the range of predetermined values, the sensor value may also be determined to be abnormal. In the case where the APC system 40 obtains data on such a state of the apparatus, the derivation of an APC recipe fails.

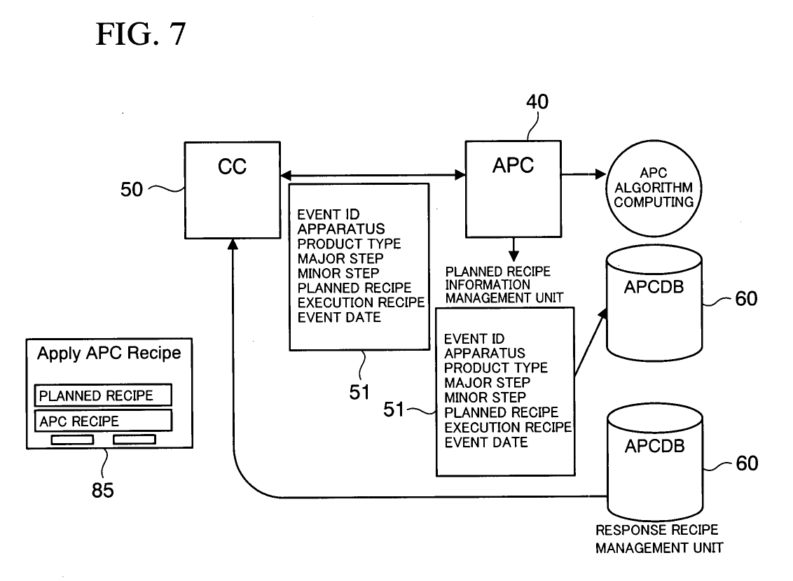

Referring to FIG. 7, a description will be given of means for preventing the CC system 50 from stopping even in the case where an APC recipe computation results in an error as described above.

In this embodiment, a recipe to be transmitted to the CC system 50 is set beforehand in preparation for the case where the derivation of a recipe has failed. This recipe set beforehand is referred to as a “planned recipe” here.

The planned recipe is a recipe defined so that the finished precision of semiconductor devices processed by the manufacturing process falls within specification values, and set before lot processing to be stored in the database 60 of the APC system 40. This planned recipe is a recipe which does not depend on the judgments of engineers and operators, and set in a manufacturing management system (CC system 50) beforehand. The APC system 40 obtains the planned recipe with lot information.

It should be noted that the planned recipe is not effective in the case of products requiring high precision because no consideration is given to information on the manufacturing apparatus 20 and external factors such as atmospheric pressure which affect the quality of the semiconductor devices. However, even in this case, the CC system 50 can be prevented from stopping by the CC system 50 obtaining the planned recipe.

Hereinafter, a specific method of obtaining the planned recipe by the APC system 40 will be described.

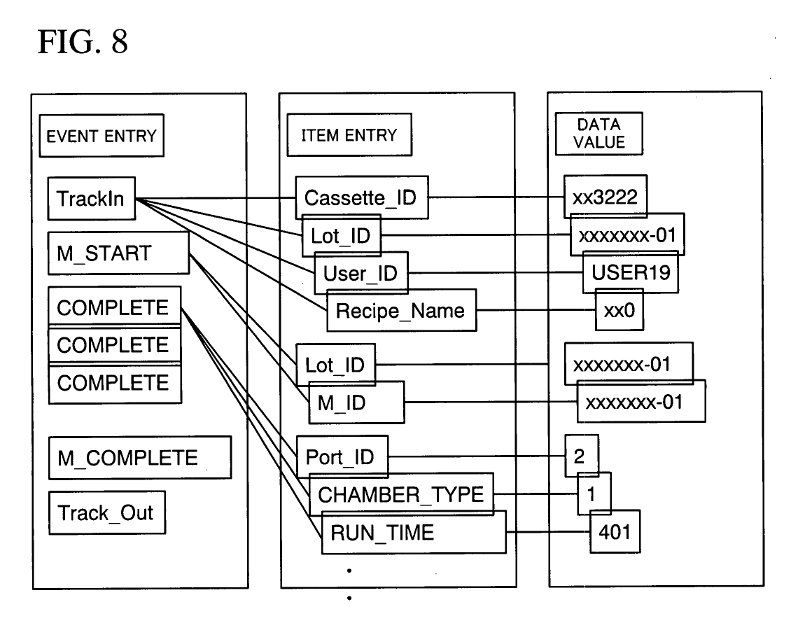

The APC system 40 collects event data 51 from the CC system 50. In the collected event data 51, events such as TrackIn and M_START are defined as shown in FIG. 8. Among these, a TrackIn event is selected. The TrackIn event contains data indicating information concerning a lot to be tracked. There are item entries including Cassette_ID for identifying a cassette, Lot_ID for identifying a wafer, Recipe_Name for identifying the planned recipe, and the like. Among these entries, the planned recipe is selected. The selected planned recipe is added to a response recipe management table.

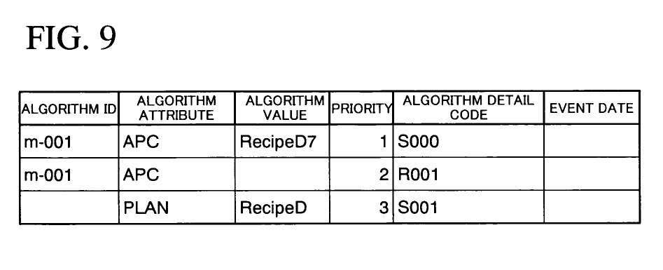

FIG. 9 is one example of the response recipe management table stored in the database 60. This response recipe management table includes entries which are an algorithm ID, an algorithm attribute, an algorithm value, a priority, an algorithm detail code, and an event DATE.

The algorithm ID indicates an identification number of an algorithm used to derive a recipe, i.e., the name of the algorithm. The algorithm attribute is intended to identify whether an APC computation has been performed using the algorithm indicated by the algorithm ID or the preset planned recipe is used. In the case where an APC computation has been performed, the algorithm attribute is set to APC; meanwhile, in the case of the planned recipe, the algorithm attribute is set to PLAN. The algorithm value is a recipe value (recipe name) returned by the APC system 40 and is an output value obtained by performing a computation according to a predetermined algorithm. The priority specifies the priority of a recipe to be transmitted to the CC system 50. The algorithm detail code is a criterion given to each recipe.

For example, the planned recipe is stored as in the third row of the response recipe management table shown in FIG. 9. Thus, for the planned recipe, a recipe value (algorithm value) is defined (in the example of FIG. 9, RecipeD), and an algorithm detail code is also determined beforehand.

The response recipe management table shown in FIG. 9 shows the case where the derivation of an APC recipe has been performed normally. In the case where an APC recipe has been derived normally, a recipe value as the result thereof is stored in an appropriate place in the first row of the table to be priority 1. Further, when a request to obtain a recipe value is issued from the CC system 50, the APC system 40 returns a recipe value of priority 1.

It should be noted that there are cases where an optimum recipe is derived based on the latest processing conditions, depending on the semiconductor device manufacturing process. Here, the latest processing conditions are manufacturing data or the like used to derive a recipe for a preceding lot. Accordingly, when an optimum APC recipe cannot be derived because of the occurrence of an error at the time of the derivation of an APC algorithm, there is a possibility that precision becomes higher when the latest processing conditions are used than when the planned recipe is used.

In consideration of such a case, instead of returning the planned recipe to the CC system 50, an inquiry screen 85 may be displayed on a display screen of the APC operation terminal 81a so that an operator select any one of an APC recipe derived using the latest processing conditions and the planned recipe.

Specifically, each of the planned recipe and the APC recipe is combined with an application condition, and an inquiry is made at an operator so that the operator can select a recipe. Here, an application condition is an algorithm detail code corresponding to each recipe and is intended to provide notification of information specific to the case where the recipe is used. For example, notification that a reference value is exceeded or notification of a concern of exceeding a reference value is provided.

(Method of Controlling Semiconductor Device Manufacturing Process for Preventing CIM System from Stopping)

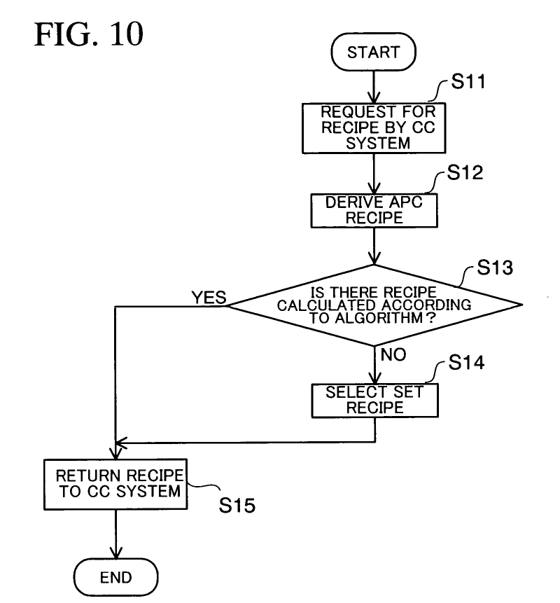

FIG. 10 is a flowchart showing one example of processing of the first embodiment.

First, in step S11, the CC system 50 requests a recipe from the APC system 40.

In the next step S12, the APC system 40 starts the derivation of a recipe. At the time of the derivation of a recipe, the APC system 40 obtains data necessary for the derivation of a recipe from the CC system 50.

In the next step S13, a determination is made as to whether or not a recipe has been derived. The APC system 40 performs the derivation of a recipe by obtaining information such as measurement results from the CC system 50. However, there may be cases where the obtained information is defective. In consideration of such cases, the derivation of a recipe is set beforehand so as to be capable of being performed several times. In the case where a result cannot be obtained even when the derivation of a recipe is performed again, a determination is made that a recipe cannot be derived. If a recipe can be derived, the flow goes to step S15, and the recipe is returned to the CC system 50. If a recipe is not derived, the flow goes to the next step S14.

In the next step S14, a recipe to be returned to the CC system 50 is selected. A recipe selected here is a preset recipe (alternative recipe). Preset recipes include the planned recipe and APC recipes derived using predetermined algorithms. Further, the APC recipes derived using the predetermined algorithms also include a recipe obtained by deriving a recipe based on the latest processing conditions. Among these recipes, an optimum recipe is selected, the flow goes to step S15, and the recipe is returned to the CC system 50.

As described above, in the semiconductor device manufacturing process control system (APC system 40) according to this embodiment, a response recipe which does not significantly impair product quality is prepared. Accordingly, even in the case where an APC recipe computation has failed, a recipe can be returned to the CC system 50. Thus, the CC system 50 can be prevented from stopping, and it becomes possible to manufacture high-quality semiconductor devices in an automated semiconductor device factory.

### (2) Second Embodiment

In the first embodiment, even in the case where an optimum APC recipe is not derived in the APC system 40, a recipe is selected to be returned to the CC system 50 by preparing recipes beforehand. In a second embodiment, a specific method of selecting a recipe is specified. The configuration of a semiconductor device manufacturing system 100 used in this embodiment is the same as that described in the first embodiment.

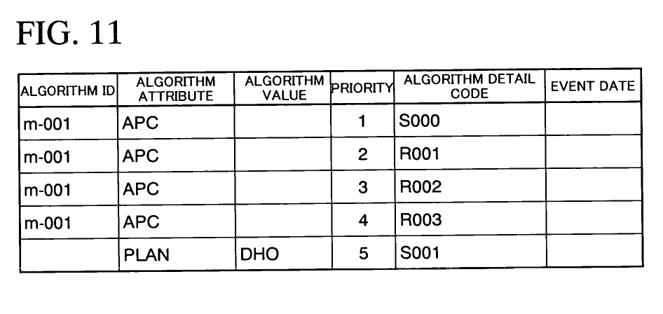

FIG. 11 is a view showing one example of a response recipe management table for the case where the derivation of an APC recipe has failed. Data in the first row indicate that as a result of performing an APC calculation using algorithm m-001, an algorithm value (recipe value) has not been obtained. That is, the following situation is indicated: when apparatus information and the like are obtained from the CC system 50 and a computation of a recipe value is performed using a predetermined algorithm, a recipe value cannot be derived for a reason such as a shortage of measurement points, and a value cannot be stored in an algorithm value in the response recipe management table. Thus, in the case where a field for an algorithm value is blank, a determination is made that a recipe value cannot be derived and that a computation has failed.

In this embodiment, a plurality of recipe derivation patterns are prepared beforehand in preparation for the case where an algorithm value cannot be derived. As shown in FIG. 11, there are recipe derivation patterns of priorities 1 to 5. Here, the recipe derivation patterns of priorities 2 to 5 are set beforehand and fixed. Further, the priorities and algorithm detail codes correspond to each other in a one-to-one relationship. Furthermore, the planned recipe is set as a recipe of priority 5. The purpose is to provide a guarantee that a recipe value can be transmitted to the CC system 50 even in the case where the derivation of an APC recipe has failed up to priority 4.

Hereinafter, the derivation of a recipe for the case where an algorithm computation has failed will be described.

As shown in FIG. 11, in the case where an algorithm value of priority 1 does not exist, the level of the priority is lowered by one, and processing specified by priority 2 is performed. In FIG. 11, the algorithm detail code of priority 2 is R001. When an algorithm detail code is Rxx, a recomputation is specified. In the case of R001, a recomputation under the same conditions is specified. Accordingly, a recomputation is performed under the same conditions using the same algorithm as the computation of priority 1.

In the case where the computation has succeeded, an algorithm value and an algorithm detail code as results of the computation are stored in appropriate fields of priority 1. Further, if a value exists in the algorithm value of priority 1, the value is returned as a recipe value to the CC system 50.

On the other hand, in the case where an algorithm computation of priority 2 has also failed, a value is not stored in the field of the algorithm value of priority 1, and this field remains blank. Accordingly, since an algorithm value of priority 1 does not exist, processing specified by the recipe derivation pattern of the next priority 3 is performed.

The algorithm detail code of priority 3 is R002. When an algorithm detail code is R002, a recomputation using an average film thickness is specified. Accordingly, a recomputation is performed using an average film thickness (here, the average of film thicknesses on a wafer in a phase before an etching step). Processing for the case where the computation has succeeded and that for the case where the computation has failed are similar to those of the above-described priority 2.

If an algorithm value of priority 1 does not exist, then processing specified by the recipe derivation pattern of priority 4 is performed. The algorithm detail code of priority 4 is R003. When an algorithm detail code is R003, a recomputation using the etching rate of a previous lot is specified. Accordingly, a recomputation is performed using a previous rate (etching rate used for a lot previous to a current object lot).

In the case where recipe derivation of priority 4 has also failed, processing specified by the recipe derivation pattern of priority 5 is performed. For priority 5, the planned recipe has been set beforehand, and an algorithm value has also been set. In the case where APC recipe computations have failed and priority 5 has been reached, the algorithm value of priority 5 is transmitted to the CC system 50.

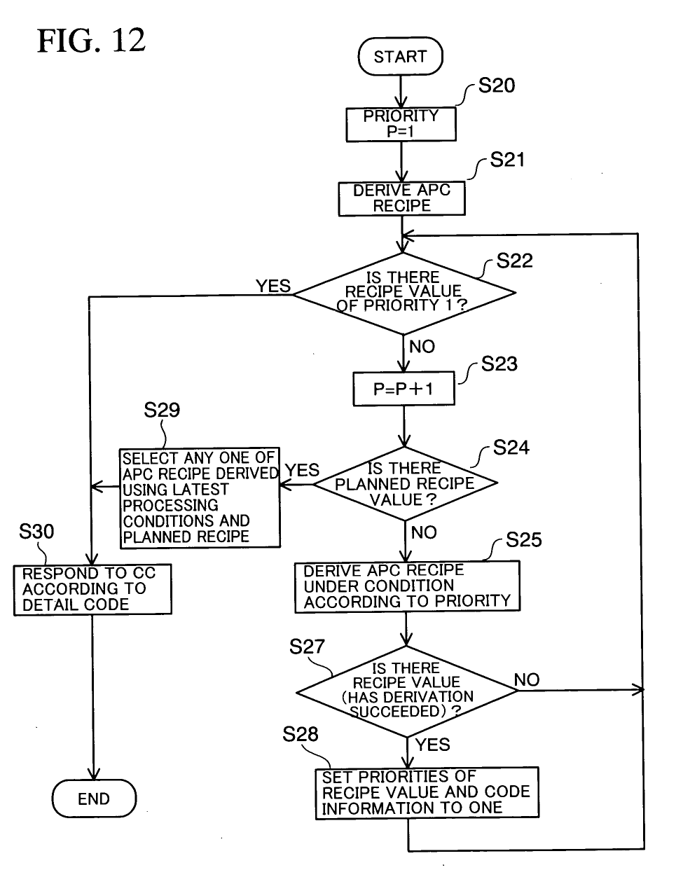

Hereinafter, processing of this embodiment will be described using the flowchart of FIG. 12. Here, it is assumed that the CC system 50 requests a recipe and that the APC system 40 has obtained from the CC system 50 information and the like on an object lot which are necessary to derive an APC recipe.

First, in step S20, the priority is set to one as preprocessing.

In the next step S21, the derivation of a recipe value is performed using an algorithm specified by the recipe derivation pattern of priority 1. If the derivation of a recipe has succeeded, an algorithm value and an algorithm detail code are stored in appropriate fields. In the case where the derivation of a recipe has failed, the field for an algorithm value remains blank.

In the next step S22, a determination is made as to whether or not an algorithm value (recipe value) of priority 1 exists. If a recipe value exists, the flow goes to step S30; meanwhile, if a recipe value does not exist, the flow goes to step S23.

In the next step S23, which is processing for the case where a recipe value of priority 1 does not exist, the level of the priority is lowered by one. That is, the priority is incremented by one.

In the next step S24, a determination is made as to whether or not there is an algorithm value corresponding to the priority changed in step S23, and a determination is made as to whether or not the algorithm value is a planned recipe value. If a planned recipe value exists, the flow goes to step S29. If a planned recipe value does not exist, the flow goes to step S25.

In the next step S25, the derivation of an APC recipe is performed under a condition corresponding to the priority changed in step S23. The condition corresponding to the priority is a condition specified by the algorithm detail code corresponding to the priority and is, for example, R001, R002, or R003. Here, R001 indicates that a computation is performed again under the same condition. R002 indicates that a computation is performed again using the average value of film thicknesses. R003 indicates that a computation is performed again using an etching rate used for a lot previous to the object lot.

In the next step S27, a determination is made as to whether or not the derivation of a recipe value has succeeded. If the derivation of a recipe value has succeeded, the flow goes to step S28; meanwhile, if the derivation of a recipe value has failed, the flow goes back to step S22 to continue processing.

In the next step S28, which is processing for the case where the derivation of a recipe value has succeeded, a recipe value and an algorithm detail code are stored in appropriate fields of priority 1. Then, the flow goes back to step S22 to continue processing.

In step S24, in the case where a planned recipe exists, the flow goes to step S29. In step S29, any one of an APC recipe derived using the latest processing conditions and the planned recipe obtained in step S24 is selected. The planned recipe is a recipe defined so that the finished precision of semiconductor devices falls within specification values, and no consideration is given to information on the manufacturing apparatus 20 and external factors such as atmospheric pressure. Accordingly, there is a possibility that the precision of semiconductor devices after processing becomes higher when an APC recipe is derived using the latest processing conditions than when the planned recipe is used. For this reason, the APC recipe derived using the latest processing conditions and the planned recipe are compared to select a recipe with which the semiconductor devices can be processed with high precision.

In this selection, an operator may be inquired of and caused to make a selection.

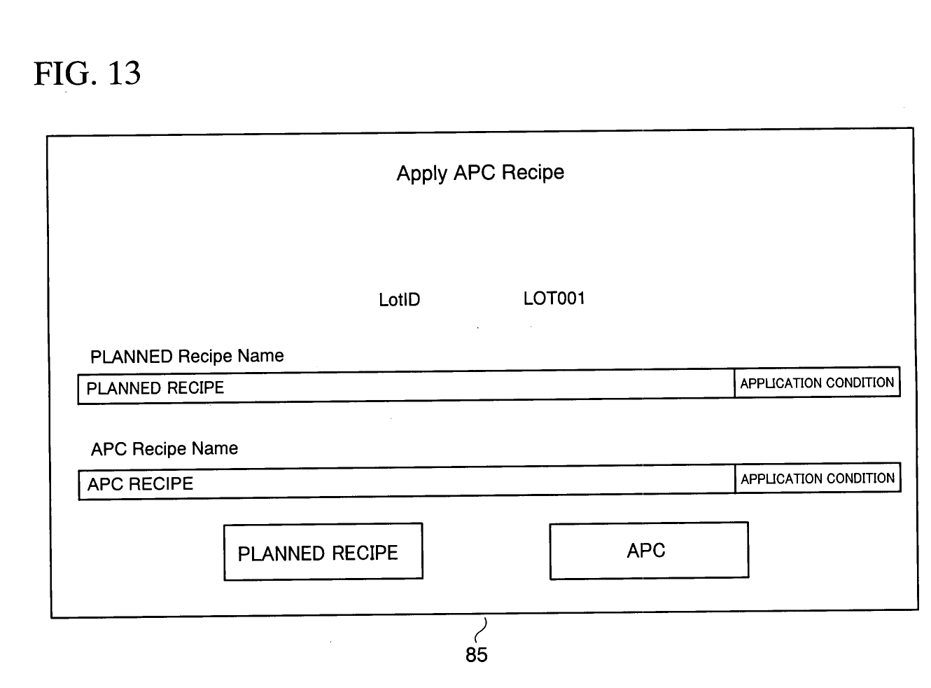

FIG. 13 shows one example of a selection screen 85 for inquiring of an operator. An inquiry to an operator is made through an APC operation terminal 81a. As a criterion for selecting a recipe by an operator, an application condition is added to each recipe. An application condition corresponds to an algorithm detail code in the response recipe management table. For example, the application condition of the APC recipe derived using the latest processing conditions is assumed to be W003, which indicates an alert; and the application condition of the planned recipe is assumed to be W007, which also indicates an alert. In this case, which recipe to select is determined with reference to the risk levels of the alerts and the like.

In the case where a recipe value of priority 1 exists in step S22, the flow goes to step S30. Further, after a recipe to be returned is selected in step S29, the flow goes to step S30.

In step S30, a recipe value is returned to the CC system 50 according to an algorithm detail code.

Algorithm detail codes include, for example, response recipe codes, alert codes, and apparatus stop codes. The response recipe codes include, for example, S000. This indicates that a recipe computation has succeeded. The apparatus stop codes include, for example, E001. This means such a case that bad-quality products are produced if an apparatus continues to be operated, and the CC system 50 is notified to stop the apparatus.

It should be noted that in the case where an apparatus stop code has been obtained as an algorithm detail code, there is a high possibility that the apparatus is abnormal. Accordingly, it is necessary to provide notification of an overhaul of the apparatus and to immediately stop the manufacture of defective products.

Moreover, in this embodiment, the state of the apparatus is not obtained again in a recalculation of an APC recipe. However, depending on an abnormality of a computation of an APC recipe, there may be cases where the state of the apparatus results in an error because unusual data caused by a sudden abnormality has been collected. A sudden abnormality of the apparatus is immediately restored in some cases. Accordingly, apparatus information may be collected in real time to prepare a recalculation condition for issuing an instruction to recalculate an APC recipe.

As described above, in the semiconductor device manufacturing process control system (APC system 40) according to this embodiment, in the case where the derivation of a recipe has failed, an input condition is changed to recompute a recipe. Accordingly, even in the case where an APC recipe computation has failed, a recipe can be returned to the CC system 50. Thus, the CC system 50 can be prevented from stopping, and it becomes possible to manufacture high-quality semiconductor devices in an automated semiconductor device factory.

### (3) Third Embodiment

In a third embodiment, a data communication method between the APC system 40 and the CC system 50 will be described.

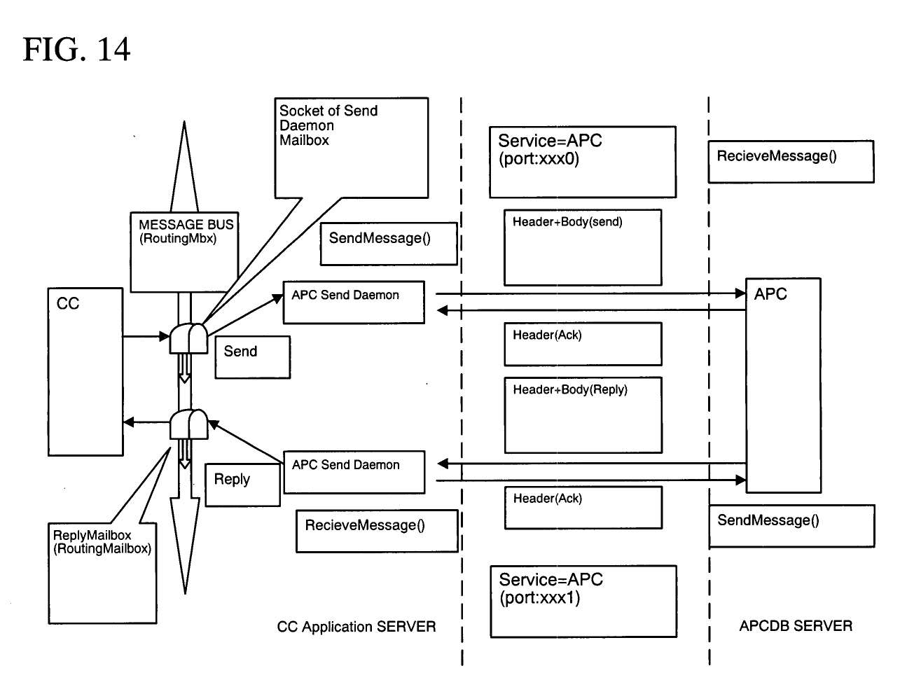

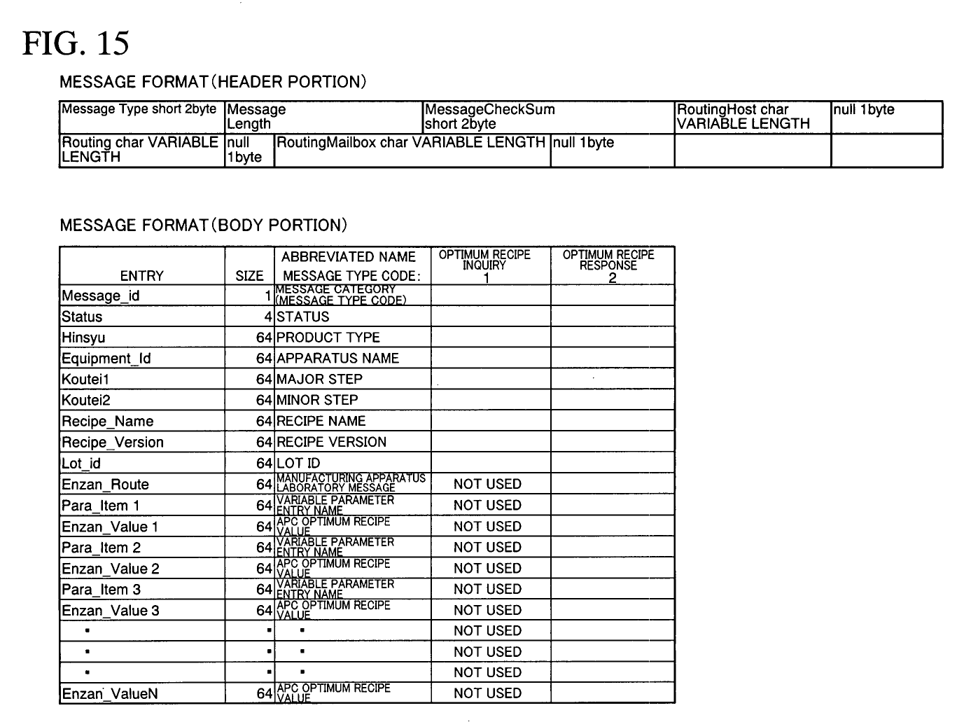

Here, referring to FIGS. 14 and 15, a description will be given by taking as an example the case where the APC system 40 cooperates with the CC system 50 and where the CC system 50 inquires of the APC system 40 as to an optimum recipe.

FIG. 14 is a diagram for explaining message communication between the CC system 50 and the APC system 40.

First, the CC system 50 passes lot information under tracking to a Send process through a message bus.

The transmission of a message from the CC system 50 to the APC system 40 is performed by a message generated according to a packet structure for an optimum recipe inquiry (message type code: 1) in a message format having a body portion such as shown in FIG. 15. That is, in the Send process by the CC system 50, data entries are generated according to a predetermined message format such as shown in FIG. 15 so as to have the packet structure for an optimum recipe inquiry. Then, a message is transmitted to the ReceiveMessage function of the APC system 40 using the SendMessage function.

The body portion of a packet used to transmit a message is divided into data entries, the sizes of the data entries, and abbreviated names of the data entries. In a packet for an optimum recipe inquiry, key entries used for process control are incorporated. That is, entries from a product type to a lot ID are incorporated as key entries. The CC system 50 generates information on the lot under tracking as a message according to the above-described packet structure, and then transmits the message to the APC system 40 from a transmitting unit.

Upon receiving the message, the APC system 40 returns a response message to the CC system 50. Then, the APC system 40 performs secondary message processing on the received message. In the secondary message processing, data entries are generated according to a packet structure for an optimum response recipe (message type code: 2) shown in FIG. 15. Other than key entry information, optimum recipe entries and parameter entries are included which are objects.

The APC system 40 transmits this secondary message to the CC system 50 from a transmitting unit, receives a response message from the CC system 50, and terminates communication between the CC system 50 and the APC system 40.

Thus, the key entries used for process control are incorporated in a packet for an optimum recipe inquiry. Further, since the value of an optimum recipe entry is derived at the time of optimum response recipe by performing secondary message processing, an optimum recipe is variable.

As described above, in the present invention, in an APC system which cooperates with a CC system, a plurality of recipes to be returned to the CC system are prepared. Accordingly, even in the case where the derivation of a recipe has failed, a recipe can be returned, and the CC system can be prevented from stopping. This makes it possible to produce high-quality semiconductor devices in an automated factory.

What is claimed is:

1. A system for controlling a semiconductor device manufacturing process, in which a recipe indicating a control condition for controlling processing in a semiconductor manufacturing apparatus is calculated by a computation performed using manufacturing data obtained in the semiconductor device manufacturing process and a predetermined algorithm, and
when the recipe cannot be derived, an alternative recipe prepared beforehand is transmitted to a manufacturing management system.

2. The system according to claim 1, wherein the alternative recipe is derived using the predetermined algorithm by a recomputation in which input conditions are changed.

3. The system according to claim 2, wherein when a recipe cannot be derived by the recomputation, a planned recipe with which semiconductor devices processed by the manufacturing process fall within specification values is used as the alternative recipe.

4. The system according to any one of claims 1 to 3, further comprising:
a database,
wherein the recipe and the alternative recipe are stored in the database in a format of a response recipe management table containing as entries an algorithm value corresponding to a recipe value, a priority determining order in which recipes are selected, and an algorithm detail code used as a criterion for a recipe; and the recipe which is transmitted to the manufacturing management system is determined based on the priority.

5. The system according to claim 4, wherein when a recipe can be derived by the recomputation, the priority of the recipe is set to one.

6. The system according to claim 5, wherein the recipe value which is transmitted to the manufacturing management system is a recipe value corresponding to priority 1 in the response recipe management table.

7. The system according to any one of claims 1 to 3, wherein a criterion according to the recipe is added to the recipe.

8. The system according to claim 7, wherein the criterion is any one of an alert, an apparatus stop, and recipe computation success.

9. The system according to claim 8, wherein the recipe which is transmitted to the manufacturing management system is determined based on the criterion added to the recipe.

10. The system according to claim 1, further comprising:
a terminal for displaying an inquiry screen,
wherein the recipe which is transmitted to the manufacturing management system is a recipe selected by a user from a plurality of recipes displayed on the inquiry screen.

11. A method of controlling a semiconductor device manufacturing process, comprising the steps of:
calculating a recipe indicating a control condition for controlling processing in a semiconductor manufacturing apparatus by a computation performed using manufacturing data obtained in the semiconductor device manufacturing process and a predetermined algorithm; and
when the recipe cannot be derived, transmitting an alternative recipe prepared beforehand to a manufacturing management system for managing the semiconductor manufacturing apparatus.

12. The method according to claim 11, wherein the alternative recipe is derived using the predetermined algorithm by a recomputation in which input conditions are changed.

13. The method according to claim 12, wherein when a recipe cannot be derived by the recomputation, a planned recipe with which semiconductor devices processed by the manufacturing process fall within specification values is used as the alternative recipe.

14. The method according to any one of claims 11 to 13, wherein the recipe and the alternative recipe are stored in a database in a format of a response recipe management table containing as entries an algorithm value corresponding to a recipe value, a priority determining order in which recipes are selected, and an algorithm detail code used as a criterion for a recipe; and the recipe which is transmitted to the manufacturing management system is determined based on the priority.

15. The method according to claim 14, wherein when a recipe can be derived by the recomputation, the priority of the recipe is set to one.

16. The method according to claim 15, wherein the recipe value which is transmitted to the manufacturing management system is a recipe value corresponding to priority 1 in the response recipe management table.

17. The method according to any one of claims 11 to 13, wherein a criterion according to the recipe is added to the recipe.

18. The method according to claim 17, wherein the criterion is any one of an alert, an apparatus stop, and recipe computation success.

19. The system according to claim 18, wherein the recipe which is transmitted to the manufacturing management system is determined based on the criterion added to the recipe.

20. The system according to claim 11, wherein the recipe which is transmitted to the manufacturing management system is a recipe selected by a user from a plurality of recipes displayed on an inquiry screen.
